(19) United States
(12) Patent Application Publication
(10) Pub. No.: US 2026/0220357 A1
(43) Pub. Date: Jul. 30, 2026

(54) INFORMATION PROCESSING DEVICE, INFORMATION PROCESSING METHOD, AND RECORDING MEDIUM

(71) Applicant: NEC Corporation, Tokyo (JP)

(72) Inventor: Masashi KAWASHIMA, Tokyo (JP)

(73) Assignee: NEC Corporation, Tokyo (JP)

(21) Appl. No.: 19/443,472

(22) Filed: Jan. 8, 2026

(30) Foreign Application Priority Data
Jan. 27, 2025 (JP) 2025-011637

(51) Int. Cl. G06F 40/166; G06F 40/20

(52) U.S. Cl. CPC G06F 40/166; G06F 40/20

(57) ABSTRACT

An information processing device includes an acquisition unit for acquiring a content of a present patent application, a reason for rejection for the present patent application, and a cited document for the present patent application, a first comparison unit for comparing one or more claims included in the present patent application with a content of the cited document without referring to the reason for rejection, a second comparison unit for comparing one or more claims included in the present patent application with the content of the cited document with reference to the reason for rejection, and a response draft creation unit for creating a response draft regarding the present patent application with reference to a comparison result by the first comparison unit and a comparison result by the second comparison unit. This system further utilizes AI-driven analysis to enable automated decision making during intermediate process after filing.

This application is based upon and claims the benefit of priority from Japanese Patent Application No. 2025-011637, filed on January 27, 2025, the disclosure of which is incorporated herein in its entirety by reference.

### TECHNICAL FIELD

The present disclosure relates to an information processing device, an information processing method, and a recording medium.

### BACKGROUND ART

Techniques for providing support related to patent applications are known. For example, JP 2010-224984 A discloses a technique for estimating a unit of indication in a notice of reasons for rejection expected for a new patent specification based on the unit of indication described in a previous notice of reasons for rejection.

### SUMMARY

However, the technique described in JP 2010-224984 A is intended to support evaluation and creation of a new application document, and cannot support intermediate process after filing.

The present disclosure has been made in view of the above problems, and an exemplary object thereof is to provide a technique capable of suitably supporting the intermediate process after filing.

An information processing device according to an exemplary aspect of the present disclosure includes an acquisition means for acquiring a content of a present patent application, a reason for rejection to the present patent application, and a cited document for the present patent application, a first comparison means for comparing one or more claims included in the present patent application with a content of the cited document without referring to the reason for rejection, a second comparison means for comparing one or more claims included in the present patent application with the content of the cited document with reference to the reason for rejection, and a response draft creation means for creating a response draft regarding the present patent application with reference to a comparison result by the first comparison means and a comparison result by the second comparison means.

An information processing method according to an exemplary aspect of the present disclosure causes one or more processors to execute acquiring a content of a present patent application, a reason for rejection to the present patent application, and a cited document to the present patent application, executing first comparison processing which is comparison between one or more claims included in the present patent application and a content of the cited document without referring to the reason for rejection, executing second comparison processing which is comparison between one or more claims included in the present patent application and the content of the cited document with reference to the reason for rejection, and creating a response draft related to the present patent application with reference to a comparison result by the first comparison processing and a comparison result by the second comparison processing.

The information processing device according to each aspect of the present disclosure may be implemented by a computer, and in this case, a program that causes the computer to operate as each unit (software element) included in the information processing device to implement the information processing device by the computer, and a computer-readable recording medium recording the program are also included in the scope of the present disclosure.

### BRIEF DESCRIPTION OF THE DRAWINGS

Exemplary features and advantages of the present disclosure will become apparent from the following detailed description if taken with the accompanying drawings in which:

FIG. 1 is a block diagram illustrating a configuration of an information processing device according to the present disclosure;

FIG. 2 is a flowchart illustrating a flow of an information processing method according to the present disclosure;

FIG. 3 is a block diagram illustrating a configuration of an information processing system according to the present disclosure;

FIG. 4 is a flowchart illustrating an example of a processing flow in an information processing system according to the present disclosure;

FIG. 5 is a diagram for explaining a processing example in an information processing system according to the present disclosure;

FIG. 6 is a diagram for explaining a processing example in an information processing system according to the present disclosure;

FIG. 7 is a diagram for explaining a processing example in an information processing system according to the present disclosure;

FIG. 8A is a diagram showing an example of output information according to the present disclosure;

FIG. 8B is a diagram showing an example of output information according to the present disclosure;

FIG. 9 is a flowchart illustrating an example of a processing flow in an information processing system according to the present disclosure;

FIG. 10 is a block diagram illustrating a configuration of an information processing system according to the present disclosure;

FIG. 11 is a block diagram illustrating a configuration of an information processing system according to the present disclosure;

FIG. 12 is a block diagram illustrating a configuration of an information processing system according to the present disclosure;

FIG. 13 is a block diagram illustrating a configuration of an information processing system according to the present disclosure;

FIG. 14 is a block diagram illustrating a configuration of an information processing system according to the present disclosure; and

FIG. 15 is a block diagram illustrating a configuration of a computer that functions as the information processing device according to the present disclosure.

### EXAMPLE EMBODIMENT

Hereinafter, example embodiments of the present disclosure will be exemplified. However, the present disclosure is not limited to the following example embodiments, and various modifications may be made within the scope described in the claims. For example, example embodiments obtained by appropriately combining techniques (some or all of objects or methods) adopted in the following example embodiments may also fall within the scope of the present disclosure. Example embodiments obtained by appropriately omitting some of the techniques adopted in the following illustrative example embodiments may also fall within the scope of the present disclosure. Effects mentioned in the following example embodiments are examples of effects expected in the example embodiments, and do not define the extension of the present disclosure. That is, example embodiments that do not exert the effects mentioned in the following example embodiments may also fall within the scope of the present disclosure.

### First Example Embodiment

A first example embodiment, which is an example of the example embodiments of the present disclosure, will be described in detail with reference to the drawings. The present example embodiment is a basic form of the individual example embodiments to be described below. An application range of each technique adopted in the present example embodiment is not limited to the present example embodiment. That is, each technique adopted in the present example embodiment may also be adopted in other example embodiments included in the present disclosure as long as no particular technical problem is raised. Each technique illustrated in the drawings referred to for describing the present example embodiment may also be adopted in other example embodiments included in the present disclosure as long as no particular technical problem is raised.

### Configuration of Information Processing Device 1

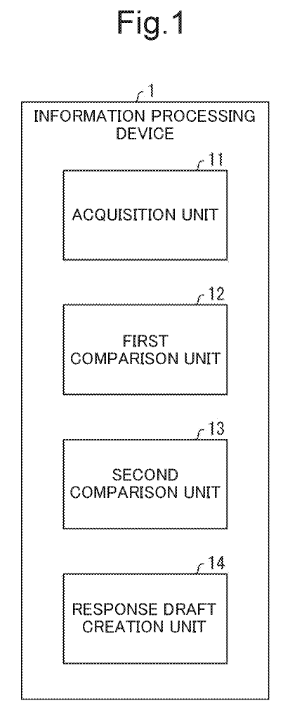

A configuration of an information processing device 1 according to the present example embodiment will be described with reference to FIG. 1. FIG. 1 is a block diagram illustrating the configuration of the information processing device 1. As illustrated in FIG. 1, the information processing device 1 includes an acquisition unit 11, a first comparison unit 12, a second comparison unit 13, and a response draft creation unit 14.

### Acquisition Unit 11

The acquisition unit 11 acquires the contents of the present patent application, the reason for rejection to the present patent application, and the cited document for the present patent application. Here, the “present patent application” indicates a patent application to be processed by the information processing device 1, and includes a specification, claims, and drawings as an example. The acquisition unit 11 acquires the claims of the patent application as the content of the present patent application. As the content of the present patent application, at least one of the specification and the drawings of the patent application may be further acquired. The term “patent application” may include “utility model”.

The reason for rejection to the present patent application refers to the reason for rejection indicated in the written opinion of the examiner (Notice of Reasons for Rejection, Decision of Rejection, etc.) issued by the Authority such as the Patent Office after filing of the present patent application. As an example, the acquisition unit 11 acquires text data of the written opinion. The cited document refers to, as an example, one or more documents cited in the written opinion of the examiner (Notice of Reasons for Rejection, Decision of Rejection, etc.). As an example, the acquisition unit 11 acquires some or all text data of the cited document. The acquisition unit 11 may also acquire some or all of the drawing data of the cited document.

### First Comparison Unit 12

The first comparison unit 12 compares one or more claims included in the present patent application with the content of the cited document (first comparison processing). Here, as an example, the first comparison unit 12 compares one or more claims included in the present patent application with the content of the cited document without referring to the reason for rejection. As an example, the first comparison unit 12 may be configured to perform the comparison using a machine learning model, a natural language processing engine, or the like.

### Second Comparison Unit 13

The second comparison unit 13 compares one or more claims included in the present patent application with the content of the cited document (second comparison processing) with reference to the reasons for rejection. As an example, the second comparison unit 13 may be configured to perform the comparison using a machine learning model, a natural language processing engine, or the like.

### Response Draft Creation Unit 14

The response draft creation unit 14 creates a response draft related to the present patent application with reference to the comparison result by the first comparison unit 12 and the comparison result by the second comparison unit 13. As an example, the response draft creation unit 14 may be configured to create the response draft using a machine learning model, a natural language processing engine, or the like. More specifically, as an example, the response draft creation unit 14 may be configured to create the response draft using a machine learning model that has learned past intermediate process data, a natural language processing engine, or the like.

### Effects of Information Processing Device 1

As described above, the information processing device 1 employs a configuration of: acquiring the content of the present patent application, the reasons for rejection to the present patent application, and the cited document to the present patent application; comparing (first comparison processing) one or more claims included in the present patent application with the content of the cited document without referring to the reasons for rejection; comparing (second comparison processing) one or more claims included in the present patent application with the content of the cited document with reference to the reasons for rejection; and creating a response draft regarding the present patent application with reference to the comparison result by the first comparison processing and the comparison result by the second comparison processing. As described above, the information processing device 1 creates a response draft with reference to the result of comparison (first comparison processing) between the one or more claims made without referring to the reason for rejection and the content of the cited document and the result of comparison (second comparison processing) between the one or more claims made with reference to the reason for rejection and the content of the cited document, so that a suitable response draft can be created. Therefore, according to the information processing device 1, it is possible to suitably support the intermediate process after the patent application. According to an exemplary aspect of the present disclosure, there is an exemplary effect that intermediate process after filing can be suitably supported.

More specifically, according to the information processing device 1, the work load in the intermediate process of the patent application is greatly reduced. In particular, by including the first comparison unit 12, it is possible to create a proposed amendment with reference to an objective analysis result that is not affected by the notice of reasons for rejection. By including the second comparison unit 13, it is possible to create a proposed amendment reflecting the content of the notice of reasons for rejection. Further, the response draft creation unit 14 can compare objective analysis with the content of the notice of reasons for rejection to more clearly grasp whether there is room for argument against the indication of the notice of reasons for rejection. As a result, it is possible to consider the proposed amendment from a more fair and comprehensive viewpoint, and as a result, high-quality intermediate process is achieved.

In the above description, a case where the information processing device 1 handles a patent application has been described as an example, but this does not limit the present example embodiment, and is applicable to a trademark or a design in addition to a patent. Specifically, the present example embodiment also includes a configuration in which: - the acquisition unit 11 acquires the content of an application relating to acquisition of an intellectual property right, the reasons for rejection to the application, and a cited document for the application; - the first comparison unit 12 compares one or more claims included in the application with the content of the cited document (first comparison processing) without referring to the reasons for rejection; - the second comparison unit 13 compares one or more claims included in the application with the content of the cited document (second comparison processing) with reference to the reasons for rejection; and - the response draft creation unit 14 creates a response draft relating to the application with reference to the comparison result by the first comparison processing and the comparison result by the second comparison processing.

With such a configuration, a suitable response draft can be created. Therefore, according to the information processing device 1, it is possible to suitably support the intermediate process after filing.

### Flow of Information Processing Method S1

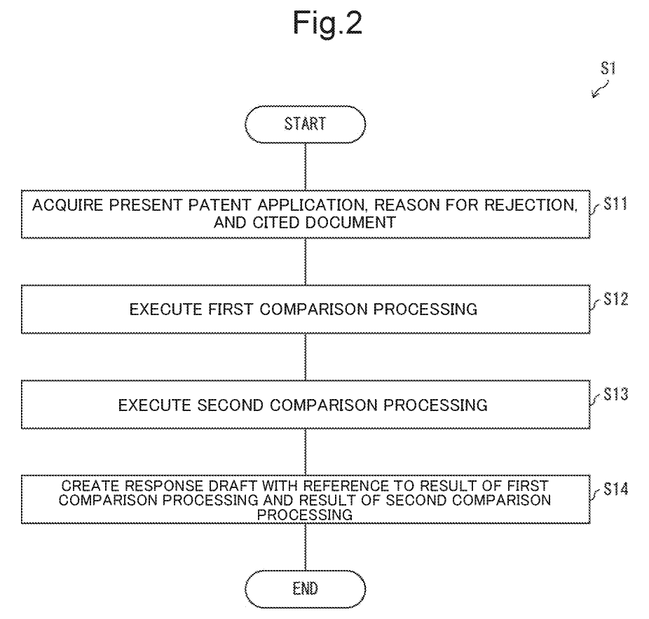

Subsequently, a flow of an information processing method S1 according to the present example embodiment will be described with reference to FIG. 2. FIG. 2 is a flowchart illustrating the flow of the information processing method S1. As illustrated in FIG. 2, the information processing method S1 includes a step (process) S11 of acquiring the present patent application, the reason for rejection, and the cited document, a step (process) S12 of executing the first comparison processing, a step (process) S13 of executing the second comparison processing, and a step (process) S14 of creating a response draft.

### Step S11

In step S11, the acquisition unit 11 acquires the content of the present patent application, the reason for rejection to the present patent application, and the cited document of the present patent application. Since a more specific description of the acquisition unit 11 has been described above, the description thereof will be omitted here.

### Step S12

In step S12, the first comparison unit 12 compares one or more claims included in the present patent application with the contents of the cited document (first comparison processing). Since a more specific description of the first comparison unit 12 has been described above, the description thereof will be omitted here.

### Step S13

In step S13, the second comparison unit 13 compares one or more claims included in the present patent application with the content of the cited document (second comparison processing) with reference to the reasons for rejection.

Since a more specific description of the second comparison unit 13 has been described above, the description thereof will be omitted here.

### Step S14

In step S14, the response draft creation unit 14 creates a response draft related to the present patent application with reference to the comparison result by the first comparison processing and the comparison result by the second comparison processing.

### Effects of Information Processing Method S1

As described above, in the information processing method S1, there is employed a configuration of: acquiring the content of the present patent application, the reasons for rejection to the present patent application, and the cited document to the present patent application; comparing (first comparison processing) one or more claims included in the present patent application with the content of the cited document without referring to the reasons for rejection; comparing (second comparison processing) one or more claims included in the present patent application with the content of the cited document with reference to the reasons for rejection; and creating a response draft regarding the present patent application with reference to the comparison result by the first comparison processing and the comparison result by the second comparison processing. According to the above configuration, an effect is provided similar to that of the information processing device 1.

In the above description, in the information processing method S1, a case where a patent application is handled has been described as an example, but this does not limit the present example embodiment, and is applicable to a trademark or a design in addition to a patent. Specifically, the present example embodiment also includes a configuration in which: - in step S11, the acquisition unit 11 acquires the content of an application relating to acquisition of an intellectual property right, the reasons for rejection to the application, and a cited document for the application; - in step S12, the first comparison unit 12 compares one or more claims included in the application with the content of the cited document (first comparison processing) without referring to the reasons for rejection; - in step S13, the second comparison unit 13 compares one or more claims included in the application with the content of the cited document (second comparison processing) with reference to the reasons for rejection; and - in step S14, the response draft creation unit 14 creates a response draft relating to the application with reference to the comparison result by the first comparison processing and the comparison result by the second comparison processing.

With such a configuration, a suitable response draft can be created. Therefore, according to the information processing method S1, it is possible to suitably support the intermediate process after filing.

### SECOND EXAMPLE EMBODIMENT

A second example embodiment, which is an example of the example embodiments of the present disclosure, will be described in detail with reference to the drawings. Components having the same functions as the components described in the example embodiment described above are denoted by the same reference signs, and descriptions thereof will be omitted as appropriate. An application range of each technique adopted in the present example embodiment is not limited to the present example embodiment. That is, each technique adopted in the present example embodiment may also be adopted in other example embodiments included in the present disclosure as long as no particular technical problem is raised. Each technique illustrated in the drawings referred to for describing the present example embodiment may also be adopted in other example embodiments included in the present disclosure as long as no particular technical problem is raised.

### Configuration of Information Processing System 100A

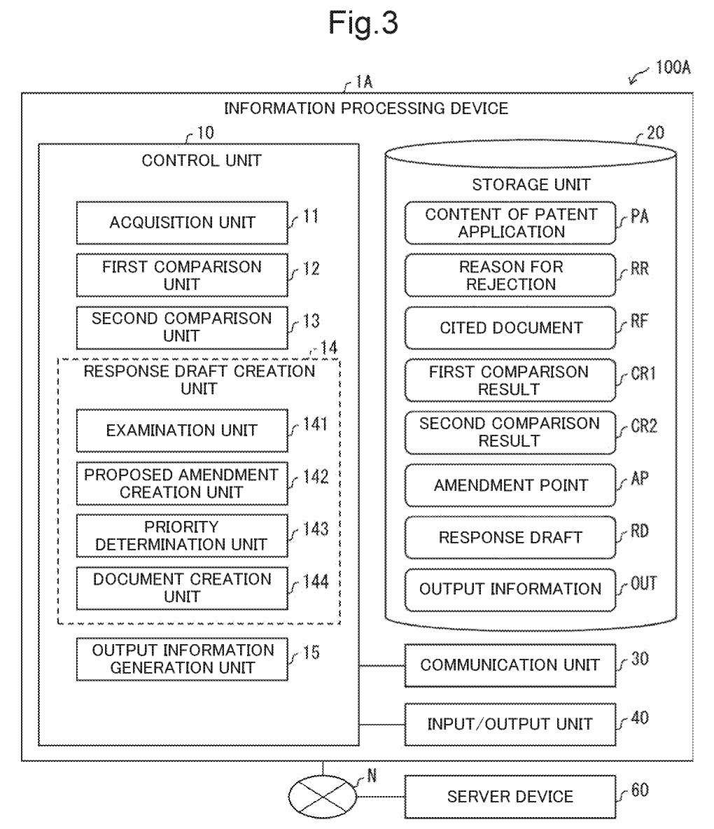

A configuration of an information processing system 100A according to the present example embodiment will be described with reference to FIG. 3. FIG. 3 is a block diagram illustrating the configuration of the information processing system 100A. As illustrated in FIG. 3, the information processing system 100A includes an information processing device 1A and a server device group 60 connected to the information processing device 1A via a network N. Here, as a specific configuration of the network N, without limiting the present example embodiment, as an example, it is possible to use a wireless Local Area Network (LAN), a wired LAN, a Wide Area Network (WAN), a public line network, a mobile data communication network, or a combination of these networks.

### Server Device Group 60

The server device group 60 includes a server device that manages a plurality of filed patent application documents. The server device provides the information processing device 1A with one or more claims, specification, drawings, and abstract related to a patent application to be processed.

The server device group 60 includes a server device that manages a written opinion of the examiner for a plurality of patent applications. The server device provides the information processing device 1A with the written opinion of the examiner regarding the patent application to be processed.

The server device group 60 includes a server device that manages a plurality of filed patent application documents, a plurality of technical documents, and the like. The server device provides the information processing device 1A with cited documents related to the patent application to be processed. Also in the present example embodiment, the term “patent application” may include “utility model”.

The server device group 60 may include a server including various models such as a machine learning model and a natural language processing engine to be described later.

### Configuration of Information Processing Device 1A

Next, a configuration of the information processing device 1A according to the present example embodiment will be described with reference to FIG. 3. As illustrated in FIG. 3, the information processing device 1A includes a control unit 10, a storage unit 20, a communication unit 30, and an input/output unit 40.

### Communication Unit 30

The communication unit 30 communicates with a device outside the information processing device 1A. As an example, the communication unit 30 communicates with the server device group 60. The data received by the communication unit 30 from the server device group 60 may include: - at least one of one or more claims, specification, drawings, and abstract related to the patent application to be processed; - written opinion of the examiner related to the patent application to be processed (Notice of Reasons for Rejection, Decision of Rejection, etc.); - cited documents related to the patent application to be processed; and the like.

### Input/Output Unit 40

The input/output unit 40 includes at least one of input/output devices such as a keyboard, mouse, a display, a printer, and a touch panel. Alternatively, the input/output unit 40 may be connected to an input/output device such as a keyboard, a mouse, a display, a printer, or a touch panel. This configuration allows the input/output unit 40 to receive inputs of various types of information to the information processing device 1A from the connected input equipment. The input/output unit 40 also outputs various types of information to the connected output equipment under control of the control unit 10. Examples of the input/output unit 40 include an interface such as, for example, a Universal Serial Bus (USB).

### Storage Unit 20

The storage unit 20 stores various types of data to be referred to by the control unit 10 and various types of data generated by the control unit 10. As an example, the storage unit 20 stores: - the content PA of the patent application; - a reason for rejection RR; - a cited document RF; - a first comparison result CR1; - a second comparison result CR2; - an amendment point AP; - a response draft RD; - an output information OUT; and the like. Here, as partially mentioned in the first example embodiment, the content PA of the patent application includes the claims of the patent application (present patent application) to be processed. The content PA of the patent application may further include at least one of the specification and the drawings of the patent application. Specific examples of the reason for rejection RR and the cited document RF will be described later.

The first comparison result CR1 includes a result of comparison processing (first comparison processing) by the first comparison unit 12 to be described later. The second comparison result CR2 includes a result of comparison processing (second comparison processing) by the second comparison unit 13 to be described later. Specific examples of the first comparison result CR1 and the second comparison result CR2 will be described later.

The amendment point AP is information output by an examination unit 141 to be described later, and includes information regarding the gist of the amendment related to the above patent application. The response draft RD is a response draft created by the response draft creation unit 14 to be described later. Specific examples of the amendment point AP and the response draft RD will be described later.

The output information OUT includes information created by the response draft creation unit 14, and includes, as an example, at least one of a remarks created by a document creation unit 144 to be described later and an amendments of the claims. A specific example of the output information OUT will be described later.

As an example, a large-capacity solid state drive (SSD) or cloud storage may be used as the storage unit 20, and a large amount of text data such as patent application documents, cited documents, and notice of reasons for rejection may be efficiently stored and managed. A high-speed data search function may be provided, and a data request from another component may be quickly responded.

### Control Unit 10

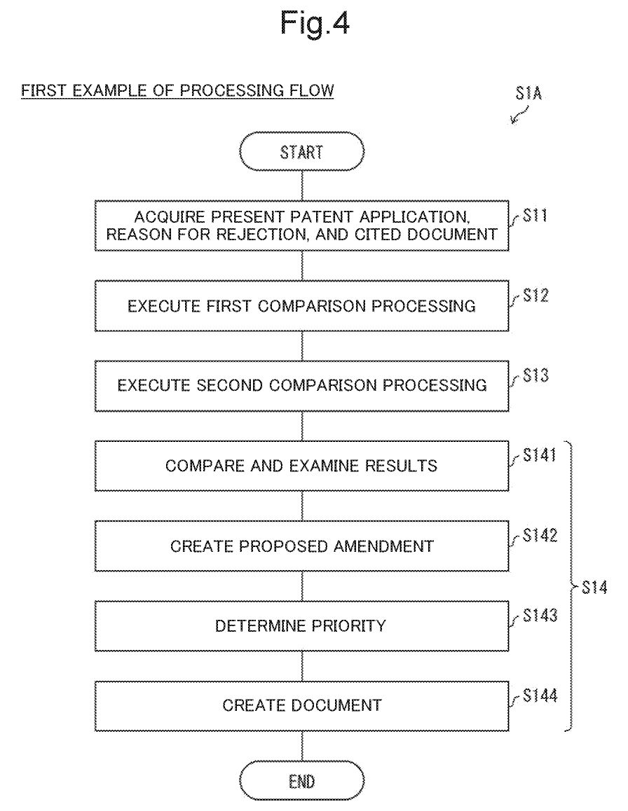

As illustrated in FIG. 3, the control unit 10 includes an acquisition unit 11, a first comparison unit 12, a second comparison unit 13, a response draft creation unit 14, and an output information generation unit 15. The response draft creation unit 14 includes an examination unit 141, a proposed amendment creation unit 142, a priority determination unit 143, and a document creation unit 144. The processing by these units will be described below with reference to a first example of the processing flow by the information processing device 1A illustrated in FIG. 4.

### First Example of Processing Flow by Information Processing Device 1A

FIG. 4 is a flowchart illustrating a first example of a processing flow executed by the information processing device 1A.

### Step S11

In step S11, the acquisition unit 11 acquires the content of the present patent application, the reason for rejection to the present patent application, and the cited document of the present patent application. Here, similarly to the first example embodiment, the “present patent application” indicates a patent application to be processed by the information processing device 1A, and includes a specification, claims, and drawings as an example. The acquisition unit 11 acquires the claims of the patent application as the content of the present patent application. As the content of the present patent application, at least one of the specification and the drawings of the patent application may be further acquired.

As in the first example embodiment, the reason for rejection to the present patent application refers to the reason for rejection indicated in the written opinion of the examiner (Notice of Reasons for Rejection, Decision of Rejection, etc.) issued by the Authority such as the Patent Office after filing of the present patent application. As an example, the acquisition unit 11 acquires text data of the written opinion. As in the first example embodiment, the cited document refers to one or more documents cited in the written opinion of the examiner (Notice of Reasons for Rejection, Decision of Rejection, etc.) as an example. As an example, the acquisition unit 11 acquires some or all text data of the cited document. The acquisition unit 11 may also acquire some or all of the drawing data of the cited document.

### Step S12

In step S12, the first comparison unit 12 compares one or more claims included in the present patent application with the contents of the cited document (first comparison processing) without referring to the reason for rejection. As an example, the first comparison unit 12 performs text analysis using a natural language processing technique. Specifically, techniques such as morphological analysis, syntax analysis, and semantic analysis are used in combination to compare the structures of claims and cited documents. Word embedding technique such as Word2Vec may be used for word similarity calculation to achieve more precise comparison.

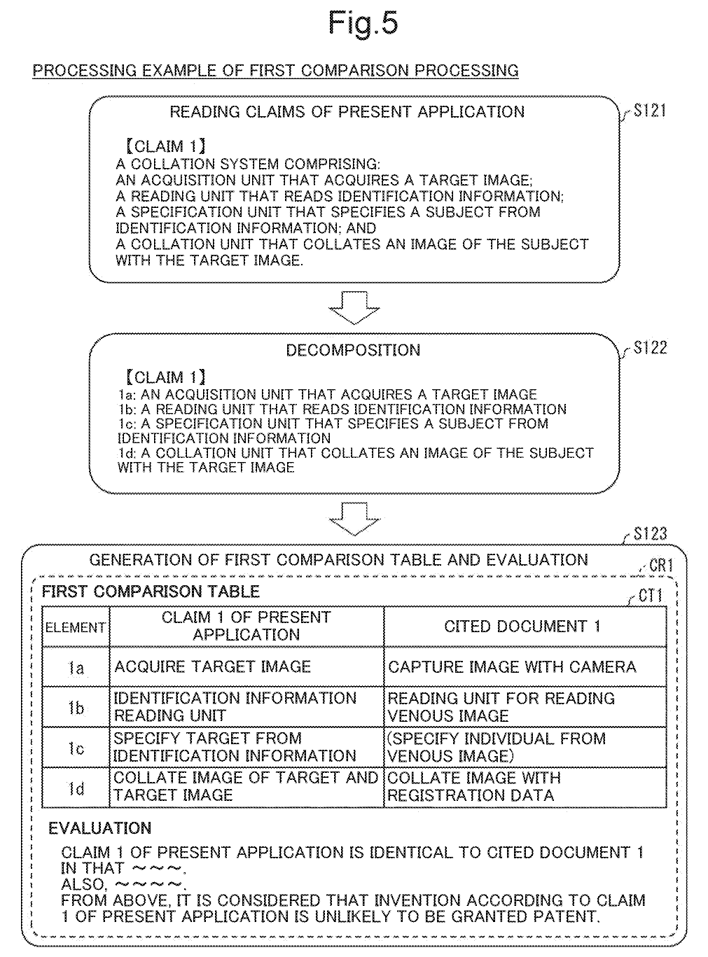

FIG. 5 illustrates a specific example of the first comparison processing in this step. In the present example, the first comparison processing includes each processing in steps S121, S122, and S123.

### Step S121

In step S121, the first comparison unit 12 reads the claims of the present patent application. In the example illustrated in FIG. 5, as claim 1 of the present patent application, the following is read.

### Claim 1

A collation system comprising:

an acquisition unit that acquires a target image;

a reading unit that reads identification information;

a specification unit that specifies a subject from identification information; and

a collation unit that collates an image of the subject with the target image.

### Step S122

In step S122, the first comparison unit 12 decomposes the claims of the present patent application.

In the example illustrated in FIG. 5, claim 1 is decomposed into elements 1a to 1d like 1a: an acquisition unit that acquires a target image; 1b: a reading unit that reads identification information; 1c: a specification unit that specifies a subject from identification information; and 1d: a collation unit that collates an image of the subject with the target image.

### Step S123

Subsequently, in step S123, the first comparison unit 12 generates the first comparison result CR1. As an example, the first comparison unit 12 generates the first comparison result CR1 without referring to the reason for rejection to the present patent application.

In the example illustrated in FIG. 5, the first comparison unit 12 generates “first comparison table CT1” and “evaluation” as the first comparison result CR1. In the “first comparison table CT1”, the first comparison unit 12 associates each element included in the claims of the present patent application with each element described in the cited document. As the “evaluation”, the first comparison unit 12 generates information such as - evaluation regarding comparison between the claims of the present patent application and the cited document, - evaluation regarding the possibility of establishing rights in the present patent application, and the like.

### Step S13

In step S13, the second comparison unit 13 compares one or more claims included in the present patent application with the content of the cited document (second comparison processing) with reference to the reasons for rejection.

As an example, the second comparison unit 13 performs text analysis using a natural language processing technique. Specifically, techniques such as morphological analysis, syntax analysis, and semantic analysis are used in combination to compare the structures of claims and cited documents. Word embedding technique such as Word2Vec may be used for word similarity calculation to achieve more precise comparison.

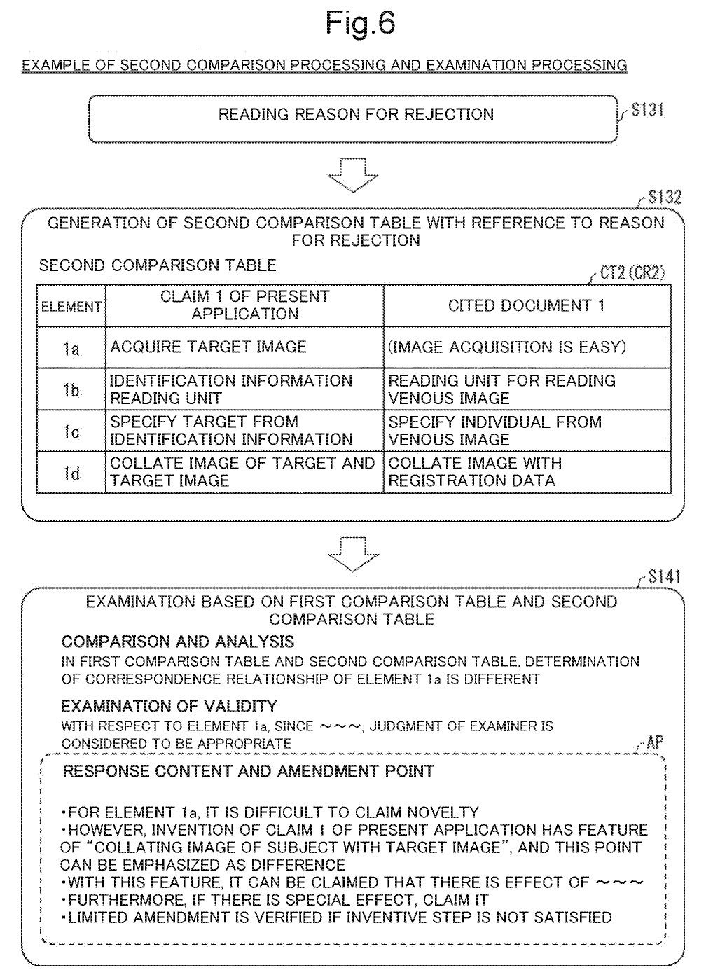

The upper and middle parts of FIG. 6 illustrate specific examples of the second comparison processing in this step. In the present example, the second comparison processing includes each processing in steps S131 and S132.

### Step S131, Step S132

In step S131, the second comparison unit 13 reads the reason for rejection to the present patent application. Then, in step S132, the second comparison unit 13 generates the second comparison result CR2 with reference to the reason for rejection.

In the example illustrated in FIG. 6, the second comparison unit 13 generates “second comparison table CT2” as the second comparison result CR2. In the “second comparison table CT2”, the second comparison unit 13 associates each element included in the claims of the present patent application with each element described in the cited document with reference to the reason for rejection. Therefore, the second comparison table reflects the opinion of the examiner in the reason for rejection.

As described later, the order of the first comparison processing in step S12 and the second comparison processing in step S13 is not limited to this example, and either one may be processed first or may be processed in parallel. The first comparison processing and the second comparison processing may be performed by different large language models (LLM) or different sessions of the same LLM.

However, in order to obtain an objective analysis result that is not affected by the notice of reasons for rejection, the first comparison processing may be performed first and then the second comparison processing may be performed.

### Step S141

Returning to FIG. 4, in step S141, the examination unit 141 examines one or more amendment points AP related to the present patent application with reference to the first comparison result CR1 and the second comparison result CR2. As an example, the examination unit 141 uses a difference detection algorithm to compare the first comparison result CR1 with the second comparison result CR2. In this algorithm, structured data of two comparison results is used as an input, and a difference therebetween is expressed by a tree structure. As an example, the examination unit 141 analyzes the tree structure of the difference to specify an amendment point. The examination unit 141 may execute at least a part of the processing using an LLM different from the first comparison unit 12 and the second comparison unit 13, or may execute at least a part of the processing by a different session of the same LLM as at least one of the first comparison unit 12 and the second comparison unit 13.

The lower part of FIG. 6 illustrates an example of the examination processing according to this step. In the example illustrated in the lower part of FIG. 6, the examination unit 141 outputs, as the examination processing, the examination results regarding: - comparison between the first comparison table CT1 and the second comparison table CT2; - examination of the appropriateness of the opinion of the examiner; -response content; and - amendment point (amendment point AP).

### Step S142

Returning to FIG. 4, in step S142, the proposed amendment creation unit 142 creates one or more proposed amendments RD related to the present patent application in accordance with the amendment point output by the examination unit 141 in step S141. As an example, the proposed amendment creation unit 142 may be configured to use a dedicated template engine for replacing, adding, or deleting a specific element while maintaining the structure of the claims.

The proposed amendment creation unit 142 may have a function of checking whether the generated proposed amendment satisfies the requirements under the Patent Law (support requirements, clarity requirements, etc.). As the check function, a general machine learning model can be used. Specifically, a machine learning model learned in advance using a wide patent literature database may be used. More specifically, the determination based on the support requirement and the clarity requirement may be automatically made by using a machine learning model in which a past patent decision document and a notice of reasons for rejection are learned in advance as learning data.

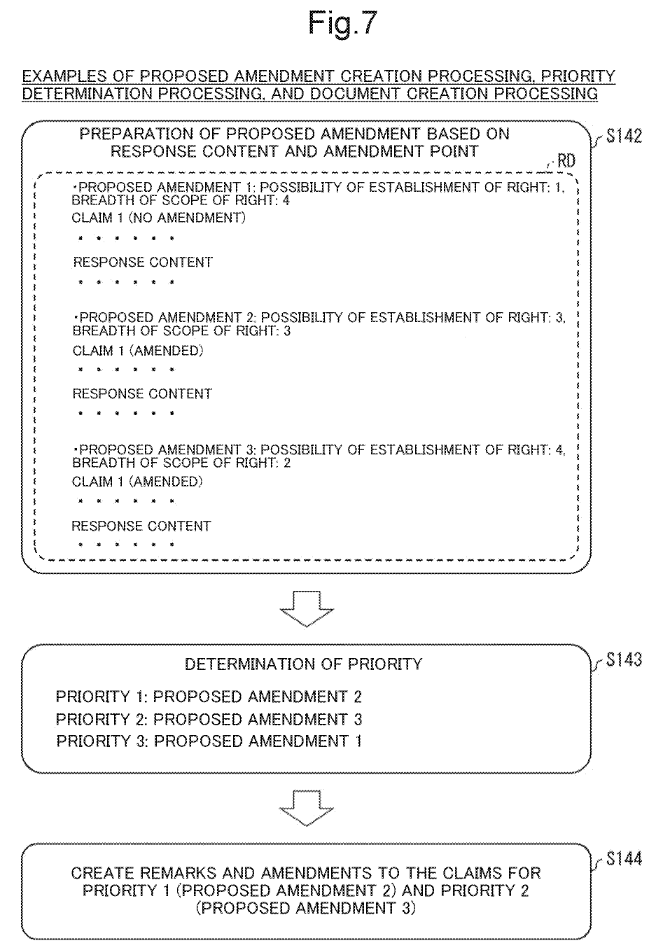

The upper part of FIG. 7 illustrates a processing example according to this step. In the example illustrated in the upper part of FIG. 7, the proposed amendment creation unit 142 creates the proposed amendment RD including the three proposed amendments (response drafts) 1 to 3, and outputs, for each of the response drafts, - the presence or absence of the amendment, - the content of the amendment, - the index indicating the possibility of establishment of rights, and - the index indicating the breadth of the right scope.

### Step S143

Returning to FIG. 4, in step S143, the priority determination unit 143 determines the priority of each of the plurality of proposed amendments generated by the proposed amendment creation unit 142 in step S142. As an example, the priority determination unit 143 may be configured to determine the priority of each proposed amendment with reference to at least one of the index indicating the possibility of establishment of the right and the index indicating the breadth of the right scope. As another example, the priority determination unit 143 may be configured to comprehensively evaluate novelty, inventive step, clarity, conformity to support requirements, and the like of each proposed amendment by using multi criteria decision making (MCDM), and select the most effective proposed amendment.

In the example illustrated in the lower part of FIG. 7, the priority determination unit 143 determines the priority of each proposed amendment such as priority 1: proposed amendment 2 priority 2: proposed amendment 3 priority 3: proposed amendment 1.

### Step S144

Next, referring back to FIG. 4, in step S144, the document creation unit 144 refers to the priority determined by the priority determination unit 143, and creates remarks and amendments regarding one or more proposed amendments having a relatively high priority. As an example, the document creation unit 144 uses a language model that learns expressions and patterns of logical expansion that are generally used in patent practice, and generates a natural and convincing document as created by a human. In the example illustrated in the lower part of FIG. 7, the document creation unit 144 creates remarks and amendments of claims for the response draft 2 having the first priority and the response draft 3 having the second priority.

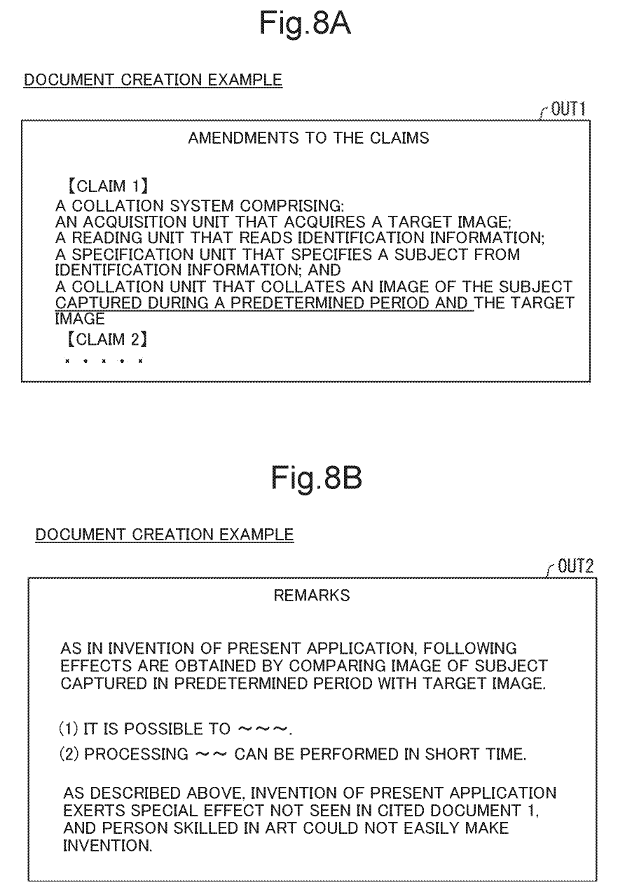

FIG. 8A illustrates an example of the output information OUT including an amendment OUT1 created by the document creation unit 144. FIG. 8B illustrates an example of the output information OUT including a remarks OUT2 created by the document creation unit 144. As illustrated in FIG. 8A, the document creation unit 144 creates the amendment OUT1 including the content of the amendment created by the proposed amendment creation unit 142. As illustrated in FIG. 8B, the document creation unit 144 creates the remarks OUT2 including the content of the argument created by the proposed amendment creation unit 142. As an example, the output information OUT including the amendment OUT1 and the remarks OUT2 may be visually presented to the user via the display of the input/output unit 40 or may be transmitted to the server device group 60 or the like via the communication unit 30.

### Second Example of Processing Flow by Information Processing Device 1A

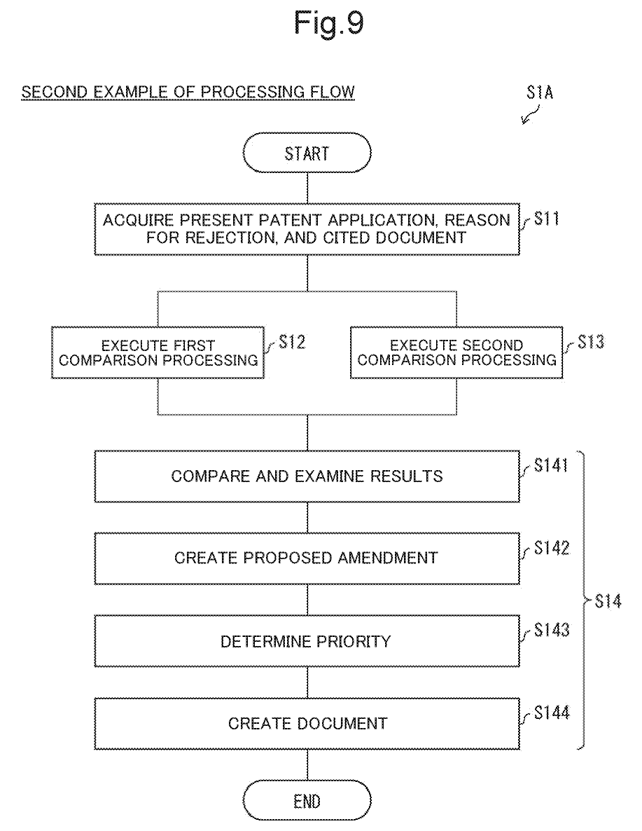

FIG. 9 is a flowchart illustrating a second example of a processing flow executed by the information processing device 1A. As illustrated in FIG. 9, the first comparison processing (step S12) and the second comparison processing (step S13) may be executed in parallel. Also by such processing, an effect substantially similar to that of the first example of the processing flow is obtained.

### Effects of Information Processing Device 1A

As described above, the information processing device 1A employs a configuration of: acquiring the content of the present patent application, the reasons for rejection to the present patent application, and the cited documents to the present patent application; comparing (first comparison processing) one or more claims included in the present patent application with the content of the cited documents without referring to the reasons for rejection; comparing (second comparison processing) one or more claims included in the present patent application with the content of the cited documents with reference to the reasons for rejection; and creating a response draft regarding the present patent application with reference to the first comparison result CR1 by the first comparison processing and the second comparison result CR2 by the second comparison processing. According to this configuration, as described in the first example embodiment, it is possible to suitably support the intermediate process after the patent application.

More specifically, according to the information processing device 1A, the work load in the intermediate process of the patent application is greatly reduced. In particular, by including the first comparison unit 12, it is possible to create a proposed amendment with reference to an objective analysis result that is not affected by the notice of reasons for rejection. By including the second comparison unit 13, it is possible to create a proposed amendment reflecting the content of the notice of reasons for rejection. Further, the response draft creation unit 14 can compare objective analysis with the content of the notice of reasons for rejection to more clearly grasp whether there is room for argument against the indication of the notice of reasons for rejection. As a result, it is possible to consider the proposed amendment from a more fair and comprehensive viewpoint, and as a result, high-quality intermediate process is achieved.

Furthermore, the information processing device 1A includes a priority determination unit 143 and a document creation unit 144. For this reason, according to the information processing device 1A, it is possible to efficiently select a proposed amendment by determining the priority and shorten the time by automatically generating the remarks and the amendments of the claims. In other words, by automatically selecting an optimum one from a plurality of proposed amendments and generating necessary documents based on the selected optimum one, it is possible to greatly reduce the working time while supporting the judgment of the patent expert.

### THIRD EXAMPLE EMBODIMENT

A third example embodiment, which is an example of the example embodiments of the present disclosure, will be described in detail with reference to the drawings. Components having the same functions as the components described in the example embodiment described above are denoted by the same reference signs, and descriptions thereof will be omitted as appropriate. An application range of each technique adopted in the present example embodiment is not limited to the present example embodiment. That is, each technique adopted in the present example embodiment may also be adopted in other example embodiments included in the present disclosure as long as no particular technical problem is raised. Each technique illustrated in the drawings referred to for describing the present example embodiment may also be adopted in other example embodiments included in the present disclosure as long as no particular technical problem is raised.

### Configuration of Information Processing System 100B

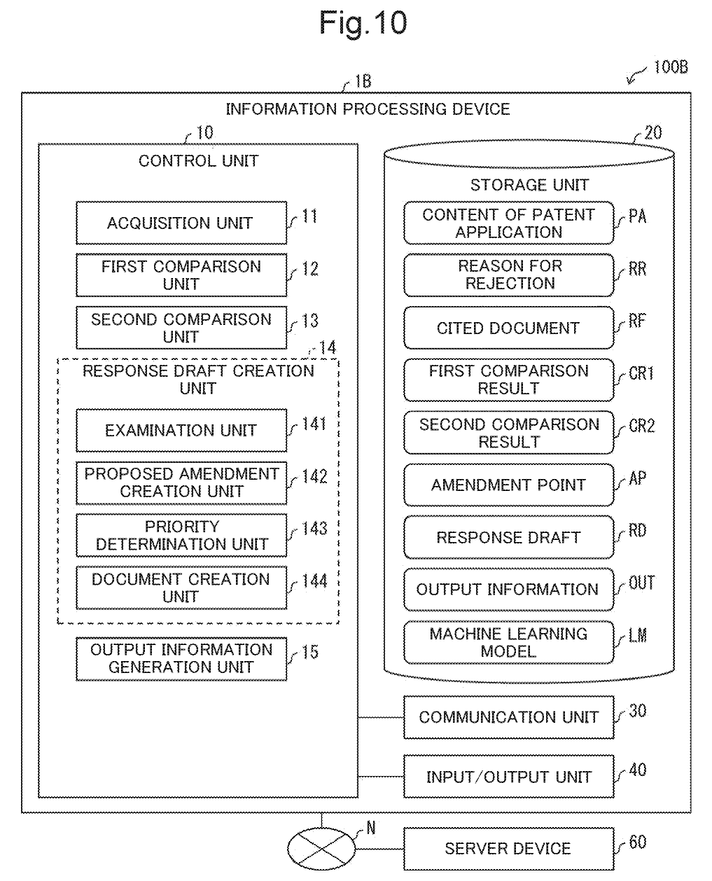

A configuration of an information processing system 100B according to the present example embodiment will be described with reference to FIG. 10. FIG. 10 is a block diagram illustrating the configuration of the information processing system 100B. As illustrated in FIG. 10, the information processing system 100B includes an information processing device 1B and a server device group 60 connected to the information processing device 1B via a network N. Since the server device group 60 is similar to that of the second example embodiment, redundant description will be omitted.

### Information Processing Device 1B

The information processing device 1B has a configuration substantially similar to that of the information processing device 1A according to the second example embodiment, but differs in the following points.

The storage unit 20 included in the information processing device 1B stores a machine learning model LM. More specifically, the storage unit 20 stores one or more parameters defining the machine learning model LM.

As an example, a deep learning model is adopted as the machine learning model LM, and the deep learning model is pre-trained using a large amount of patent documents and history data of intermediate process (Notice of Reasons for Rejection, Notice of Decision of Rejection, Information of Examiner in Charge, Stage of Rejection (Final, Decision of Rejection, etc.), Amendment, Written Argument, etc.). The deep learning model may be adapted to a specific technical field or characteristics of each applicant by using a transfer learning method.

As an example, the machine learning model LM is incorporated in the proposed amendment creation unit 142 and the priority determination unit 143, and can be configured to more effectively generate the proposed amendment and determine the priority by learning the past intermediate process data. In other words, the response draft creation unit 14 includes a machine learning model that is incorporated in at least one of the proposed amendment creation unit 142 and the priority determination unit 143, learns past intermediate process data, and performs at least one of creation of a proposed amendment and determination of priority.

The information processing device 1B according to the present example embodiment further has the following effects in addition to the effects described in each of the above-described example embodiments by having the above-described configuration. That is, the machine learning model LM improves the accuracy of the proposed amendment creation (success probability for patent registration). By learning the past intermediate process data, the performance of the system is improved over time, and a more appropriate and effective proposed amendment can be proposed. As a result, it is possible to efficiently utilize the experience and knowledge of the patent specialist while increasing the possibility of patent registration.

### FOURTH EXAMPLE EMBODIMENT

A fourth example embodiment, which is an example of the example embodiments of the present disclosure, will be described in detail with reference to the drawings. Components having the same functions as the components described in the example embodiment described above are denoted by the same reference signs, and descriptions thereof will be omitted as appropriate. An application range of each technique adopted in the present example embodiment is not limited to the present example embodiment. That is, each technique adopted in the present example embodiment may also be adopted in other example embodiments included in the present disclosure as long as no particular technical problem is raised. Each technique illustrated in the drawings referred to for describing the present example embodiment may also be adopted in other example embodiments included in the present disclosure as long as no particular technical problem is raised.

### Configuration of Information Processing System 100C

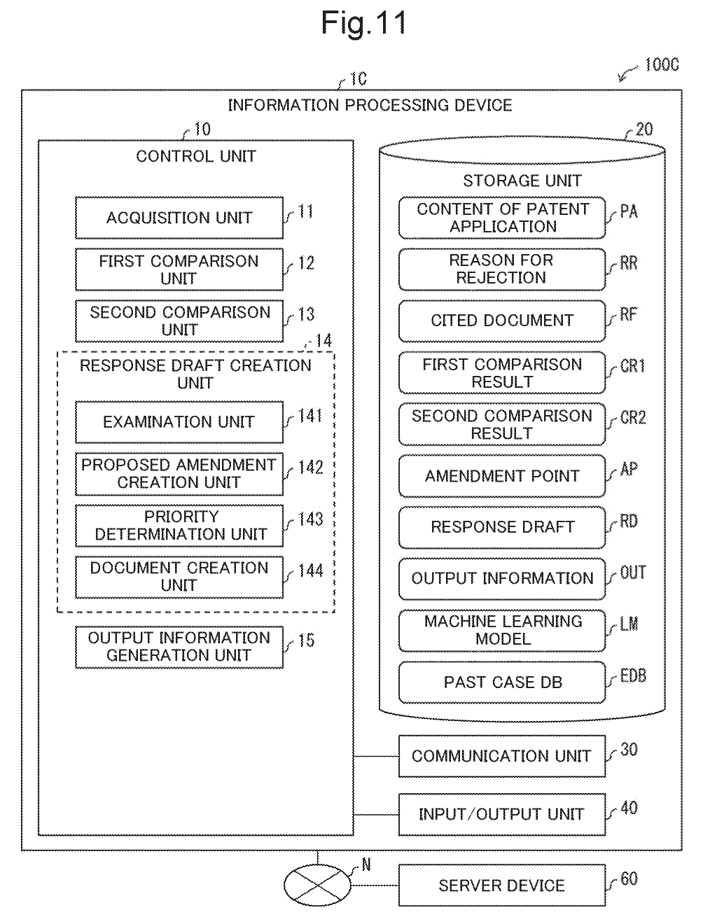

A configuration of an information processing system 100C according to the present example embodiment will be described with reference to FIG. 11. FIG. 11 is a block diagram illustrating a configuration of the information processing system 100C. As illustrated in FIG. 11, the information processing system 100C includes an information processing device 1C and a server device group 60 connected to the information processing device 1C via a network N. Since the server device group 60 is similar to that of the second example embodiment, redundant description will be omitted.

### Information Processing Device 1C

The information processing device 1C has a configuration substantially similar to that of the information processing device 1B according to the third example embodiment, but differs in the following points.

A past case database EDB is stored in the storage unit 20 included in the information processing device 1C. Here, the past case database EDB adopts the NoSQL database technique as an example, and stores a large number of intermediate process cases in a flexible schema.

As an example, a similarity-based search technique can be used for the query to the past case database EDB. For example, a feature vector of a current case is generated, and a past similar case is searched at high speed using an index such as cosine similarity. As a result, it is possible to efficiently refer to past response examples to similar technical fields and reasons for rejection. The criterion of similarity may be arbitrarily set, and may be the similarity of the inventor, the content of the notice of reasons for rejection, the technical field, the examiner, the entire patent document, or the like. These may be combined in a complex manner.

As described above, the information processing device 1C further includes, as an example, a past case database that stores past intermediate process cases as structured data and that is referred to by the proposed amendment creation unit 142 and the priority determination unit 143.

The information processing device 1C according to the present example embodiment further has the following effects in addition to the effects described in each of the above-described example embodiments by having the above-described configuration. That is, it is possible to improve the efficiency of creating a proposed amendment with reference to a similar case. The past intermediate process case is stored as structured data, and the past case similar to the current case is quickly searched and referred to, so that an effective proposed amendment can be created. This makes it possible to systematize the experience of patent experts and share and utilize the experience throughout the entire organization.

### FIFTH EXAMPLE EMBODIMENT

A fifth example embodiment, which is an example of the example embodiments of the present disclosure, will be described in detail with reference to the drawings. Components having the same functions as the components described in the example embodiment described above are denoted by the same reference signs, and descriptions thereof will be omitted as appropriate. An application range of each technique adopted in the present example embodiment is not limited to the present example embodiment. That is, each technique adopted in the present example embodiment may also be adopted in other example embodiments included in the present disclosure as long as no particular technical problem is raised. Each technique illustrated in the drawings referred to for describing the present example embodiment may also be adopted in other example embodiments included in the present disclosure as long as no particular technical problem is raised.

### Configuration of Information Processing System 100D

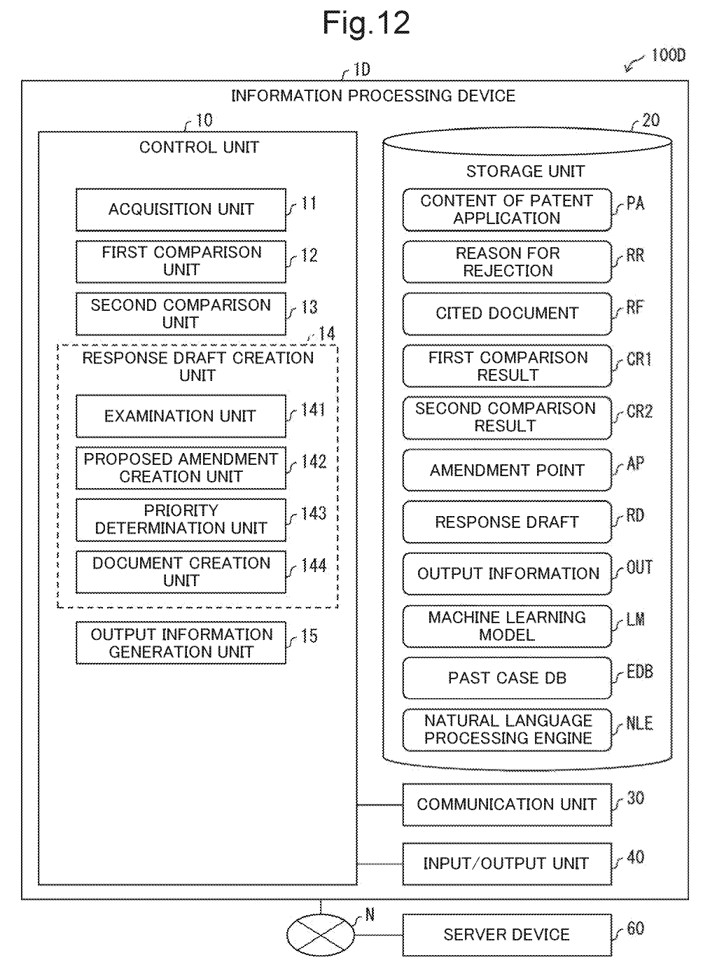

A configuration of an information processing system 100D according to the present example embodiment will be described with reference to FIG. 12. FIG. 12 is a block diagram illustrating a configuration of the information processing system 100D. As illustrated in FIG. 12, the information processing system 100D includes an information processing device 1D and a server device group 60 connected to the information processing device 1D via a network N. Since the server device group 60 is similar to that of the second example embodiment, redundant description will be omitted.

### Information Processing Device 1D

The information processing device 1D has a configuration substantially similar to that of the information processing device 1C according to the fourth example embodiment, but differs in the following points.

The storage unit 20 included in the information processing device 1D stores a natural language processing engine NLE. More specifically, the storage unit 20 stores one or more parameters that define the natural language processing engine NLE.

The natural language processing engine NLE employs, as an example, a pre-trained large scale language model (examples: GPT (registered trademark), BERT, etc.) to achieve deeper semantic understanding in view of context. As an example, the natural language processing engine NLE is incorporated in the first comparison unit 12 and the second comparison unit 13. As the natural language processing engine NLE, in particular, a special language model subjected to preliminary learning in a patent document may be used in order to cope with technical terms and expressions specific to patents. As a result, a relationship between synonyms and superordinate/subordinate concepts is more accurately grasped, and high-precision comparison is achieved.

As described above, the information processing device 1D includes the natural language processing engine NLE that is incorporated in at least one of the first comparison unit 12 and the second comparison unit 13 and performs comparison using a natural language processing technique.

The information processing device 1D according to the present example embodiment further has the following effects in addition to the effects described in each of the above-described example embodiments by having the above-described configuration. That is, it is possible to improve the comparison accuracy by the natural language processing technique. This effect is achieved by achieving accurate understanding and analysis of complex technical terms and expressions, accurate comparison by deep semantic understanding in consideration of context, and comprehensive comparison by appropriate processing of synonyms and similar expressions. As a result, more accurate and reliable comparison results are obtained, and the quality of the proposed amendment is improved.

### SIXTH EXAMPLE EMBODIMENT

A sixth example embodiment, which is an example of the example embodiments of the present disclosure, will be described in detail with reference to the drawings. Components having the same functions as the components described in the example embodiment described above are denoted by the same reference signs, and descriptions thereof will be omitted as appropriate. An application range of each technique adopted in the present example embodiment is not limited to the present example embodiment. That is, each technique adopted in the present example embodiment may also be adopted in other example embodiments included in the present disclosure as long as no particular technical problem is raised. Each technique illustrated in the drawings referred to for describing the present example embodiment may also be adopted in other example embodiments included in the present disclosure as long as no particular technical problem is raised.

### Configuration of Information Processing System 100E

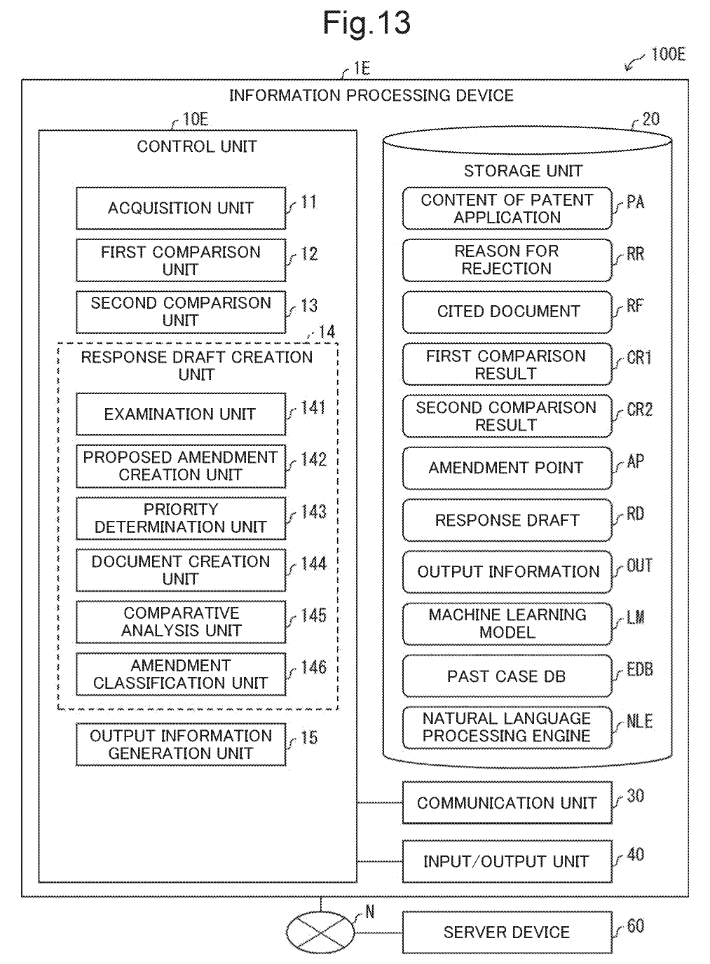

A configuration of an information processing system 100E according to the present example embodiment will be described with reference to FIG. 13. FIG. 13 is a block diagram illustrating the configuration of the information processing system 100E. As illustrated in FIG. 13, the information processing system 100E includes an information processing device 1E and a server device group 60 connected to the information processing device 1E via a network N. Since the server device group 60 is similar to that of the second example embodiment, redundant description will be omitted.

### Information Processing Device 1E

The information processing device 1E has a configuration substantially similar to that of the information processing device 1D according to the fifth example embodiment, but differs in the following points.

The control unit 10E included in the information processing device 1E includes a comparative analysis unit 145 and an amendment classification unit 146 in the response draft creation unit 14 in addition to the configuration included in the control unit 10 according to the second to fifth example embodiments.

### Comparative Analysis Unit 145

The comparative analysis unit 145 compares the comparison result by the first comparison unit 12 and the comparison result by the second comparison unit 13 for all of one or more claims included in the present patent application, and performs analysis for each component included in the one or more claims. As an example, the comparative analysis unit 145 may be configured to express the structures of the claims of the present patent application and the cited document as a tree structure and perform detailed comparison using a tree matching algorithm.

### Amendment Classification Unit 146

The amendment classification unit 146 refers to the analysis result by the comparative analysis unit 145 and classifies each of the components in the claims included in the present patent application into three of superordinate conceptualization amendment, no amendment, and limited amendment. As an example, the amendment classification unit 146 may employ a multi-class classification model by machine learning. The amendment classification unit 146 receives the output of the comparative analysis unit 145 as an input, and assigns one or a plurality of labels of “superordinate conceptualization amendment”, “no amendment”, and “limited amendment” as amendment candidates to each component. The multi-class classification model is trained using past amendment cases, and can perform appropriate classification even for new cases.

The information processing device 1E according to the present example embodiment further has the following effects in addition to the effects described in each of the above-described example embodiments by having the above-described configuration. That is, it is possible to prepare an effective amendment strategy by appropriate classification of superordinate conceptualization amendment, no amendment, and limited amendment. In particular, by including a case where limited amendment is not performed (superordinate conceptualization, no amendment), an option of extending or maintaining the scope of rights can be added to the examination target. This makes it possible to create more strategic and flexible proposed amendments, and increases the opportunity to maximize the value of the patent.

### SEVENTH EXAMPLE EMBODIMENT

A seventh example embodiment, which is an example of the example embodiments of the present disclosure, will be described in detail with reference to the drawings. Components having the same functions as the components described in the example embodiment described above are denoted by the same reference signs, and descriptions thereof will be omitted as appropriate. An application range of each technique adopted in the present example embodiment is not limited to the present example embodiment. That is, each technique adopted in the present example embodiment may also be adopted in other example embodiments included in the present disclosure as long as no particular technical problem is raised. Each technique illustrated in the drawings referred to for describing the present example embodiment may also be adopted in other example embodiments included in the present disclosure as long as no particular technical problem is raised.

### Configuration of Information Processing System 100F)

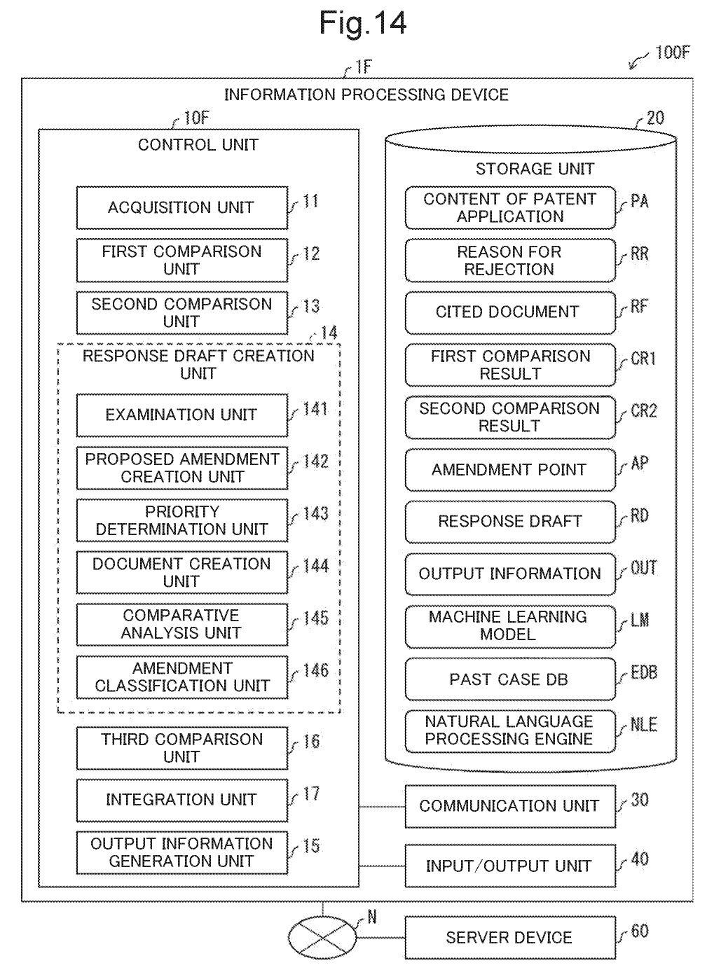

A configuration of an information processing system 100F according to the present example embodiment will be described with reference to FIG. 14. FIG. 14 is a block diagram illustrating the configuration of the information processing system 100F. As illustrated in FIG. 14, the information processing system 100F includes an information processing device 1F and a server device group 60 connected to the information processing device 1F via a network N. Since the server device group 60 is similar to that of the second example embodiment, redundant description will be omitted.

### Information Processing Device 1F

The information processing device 1F has a configuration substantially similar to that of the information processing device 1E according to the sixth example embodiment, but differs in the following points.

The control unit 10F included in the information processing device 1F includes a third comparison unit 16 and an integration unit 17 in addition to the configuration included in the control unit 10E according to the sixth example embodiment.

### Third Comparison Unit 16)

The third comparison unit 16 compares one or more claims included in the present patent application with the target configuration. Here, the target configuration is, as an example, an assumed configuration of accused product (configuration content contrasted with the claims), but this does not limit the present example embodiment. As an example, the third comparison unit 16 calculates the similarity between the claims included in the present patent application and the assumed configuration of accused product using the semantic search technique. In this process, cross-modal learning techniques are applied to make semantic associations between different document formats such as claims and product instructions.

### Integration Unit 17

The integration unit 17 (also referred to as an integration examination unit) refers to the comparison results by the first comparison unit 12, the second comparison unit 13, and the third comparison unit 16 to examine at least one of the points of the argument and the amendment. In order to comprehensively analyze three comparison results by the first comparison unit 12, the second comparison unit 13, and the third comparison unit 16, the integration unit 17 adopts an approach combining the decision tree algorithm and reinforcement learning. Specifically, a decision tree model that inputs each comparison result as a feature amount and outputs an optimal argument/amendment policy is constructed and used as the integration unit 17. This decision tree model receives the result of the actual intermediate process as a feedback and is continuously improved by reinforcement learning.

The information processing device 1E according to the present example embodiment further has the following effects in addition to the effects described in each of the above-described example embodiments by having the above-described configuration. That is, it is possible to secure an effective scope of rights by comparison with the assumed configuration of accused product. It is possible to make a strategic amendment in view of future exercise of rights by comparing with the assumed configuration of accused product. As a result, it is possible to acquire not only a patent but also a highly effective patent right in accordance with a business strategy.

### Supplementary Information 1

In each of the above-described example embodiments, a chat format may be used for input/output with respect to various learned models (machine learning model, (large-scale) language model, etc.) or input/output with respect to each unit (first comparison unit 12, second comparison unit 13, response draft creation unit 14) using these models. As an example, each unit using these models may use data in a prompt format as input data to the model. The above-described various types of data output by the units may be generated with reference to the data output from the model in the chat format.

### Supplementary Information 2

In each of the above-described example embodiments, the output information OUT is displayed on the display included in the input/output unit 40 as an example. Then, in the proposed amendment included in the output information OUT, a support portion having a configuration specified by a cursor operated by the user may be configured to be popped up. Such a configuration is implemented by, as an example, a process in which: - the response draft creation unit 14 associates each configuration included in the proposed amendment with the description in the specification relevant to the configuration; and - the input/output unit 40 pops up the description in the specification relevant to the configuration specified by the cursor.

When the user clicks a point designated by a cursor, the display area may move to a point where a support portion relevant to the configuration is displayed in the chat history data described above.

### Supplementary Information 3

In the first comparison table CT1 and the second comparison table CT2, ○ (circle mark) may be displayed if the correspondence relationship between the elements in each row is appropriate, × (cross mark) may be displayed if the correspondence relationship between the elements is inappropriate, and (triangle mark) may be output (displayed) if the correspondence relationship is not relevant to any relationship.

### Supplementary Information 4

The present disclosure is widely applicable to various organizations related to patents, such as patent law firms, corporate intellectual property departments, and patent offices. In particular, for large companies handling a large number of patent applications, small and medium companies with limited resources, and individual inventors, the present disclosure greatly contributes to the efficiency and quality improvement of the patent acquisition process.

The basic configuration of the present disclosure is also applicable to support creation of legal documents other than patents.

For example, application to a wide range of legal related business such as intellectual property related procedures such as trademarks and designs, preparation of contracts, and analysis of legal documents can be considered. As described above, the present disclosure has a possibility of being widely used in various industrial fields not only in the patent field, and greatly contributes to improvement in productivity of knowledge labor.

### Implementation Example by Software

Some or all of the functions of the information processing devices 1, and 1A to 1F (hereinafter, also referred to as “each of the above devices”) may be implemented by hardware such as an integrated circuit (IC chip) or may be implemented by software.

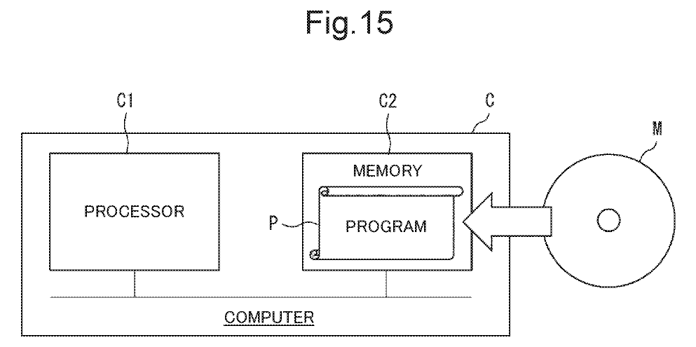

In the latter case, each of the above devices is implemented by, for example, a computer that executes a command of a program as software for implementing each function. An example of such a computer (hereinafter, referred to as a computer C) is illustrated in FIG. 15. FIG. 15 is a block diagram illustrating a hardware configuration of the computer C that functions as each of the above devices.

The computer C includes at least one processor C1 and at least one memory C2. A program P for causing the computer C to operate as each of the above devices is recorded in the memory C2. In the computer C, the processor C1 reads the program P from the memory C2 and executes it, thereby implementing the functions of each of the above devices.

As the processor C1, it is possible to use, for example, a Central Processing Unit (CPU), a Graphic Processing Unit (GPU), a Digital Signal Processor (DSP), a Micro Processing Unit (MPU), a Floating point number Processing Unit (FPU), a Physics Processing Unit (PPU), a Tensor Processing Unit (TPU), a quantum processor, a microcontroller, a combination thereof, or the like. As the memory C2, it is possible to use, for example, a flash memory, a Hard Disk Drive (HDD), a Solid State Drive (SSD), a combination thereof, or the like.

The computer C may further include a Random Access Memory (RAM) for developing the program P at the time of execution and temporarily storing various data. The computer C may further include a communication interface for transmitting and receiving data to and from another device. The computer C may further include an input/output interface for connecting input/output equipment such as a keyboard, a mouse, a display, and a printer.

The program P can be recorded on a non-transitory tangible recording medium M readable by the computer C. As such a recording medium M, it is possible to use, for example, a tape, a disk, a card, a semiconductor memory, a programmable logic circuit, or the like.

The computer C can acquire the program P via such a recording medium M. The program P can be transmitted via a transmission medium. As such a transmission medium, it is possible to use, for example, a communication network, a broadcast wave, or the like. The computer C can also acquire the program P via such a transmission medium.

Each of the above functions of each of the above devices may be implemented by a single processor provided in a single computer, may be implemented in cooperation with a plurality of processors provided in a single computer, or may be implemented in cooperation with a plurality of processors provided in each of a plurality of computers. The program for causing each of the above devices to implement each of the above functions may be stored in a single memory provided in a single computer, may be stored in a distributed manner in a plurality of memories provided in a single computer, or may be stored in a distributed manner in a plurality of memories provided in each of a plurality of computers.

### Supplementary Information A

The present disclosure includes techniques described in the following Supplementary Notes. However, the present disclosure is not limited to the techniques described in the following Supplementary Notes, and various modifications may be made within the scope described in the claims.

### Supplementary Note A1

An information processing device including:

an acquisition means for acquiring a content of a present patent application, a reason for rejection to the present patent application, and a cited document for the present patent application;

a first comparison means for comparing one or more claims included in the present patent application with a content of the cited document without referring to the reason for rejection;

a second comparison means for comparing one or more claims included in the present patent application with the content of the cited document with reference to the reason for rejection; and

a response draft creation means for creating a response draft regarding the present patent application with reference to a comparison result by the first comparison means and a comparison result by the second comparison means.

### Supplementary Note A2

The information processing device according to Supplementary Note A1, in which

the response draft creation means includes:

an examination means for examining one or more amendment points related to the present patent application with reference to a comparison result by the first comparison means and a comparison result by the second comparison means; and

a proposed amendment creation means for creating one or more proposed amendments related to the present patent application in accordance with an amendment point by the examination means.

### Supplementary Note A3

The information processing device according to Supplementary Note A2, in which

the proposed amendment creation means generates a plurality of proposed amendments, and

the response draft creation means includes:

a priority determination means for determining a priority of each of the plurality of proposed amendments created by the proposed amendment creation means; and

a document creation means for creating remarks and amendments of the claims with respect to one or more proposed amendments having a relatively high priority.

### Supplementary Note A4

The information processing device according to Supplementary Note A3, in which

the response draft creation means includes:

a machine learning model that is incorporated in at least one of the proposed amendment creation means and the priority determination means, learns past intermediate process data, and performs at least one of creation of a proposed amendment and determination of a priority.

### Supplementary Note A5

The information processing device according to Supplementary Note A3 or A4, further including a past case database that stores past intermediate process cases as structured data and is referred to by the proposed amendment creation means and the priority determination means.

### Supplementary Note A6

The information processing device according to any one of Supplementary Notes A1 to A4, including a natural language processing engine that is incorporated in at least one of the first comparison means and the second comparison means and performs comparison using a natural language processing technique.

### Supplementary Note A7

The information processing device according to any one of Supplementary Notes A1 to A4, in which

the response draft creation means includes:

a comparative analysis means for comparing a comparison result by the first comparison means and a comparison result by the second comparison means for all of one or more claims included in the present patent application and performing analysis for each component included in the one or more Supplementary Notes A; and

an amendment classification unit that classifies each of the components into three of superordinate conceptualization amendment, no amendment, and limited amendment with reference to an analysis result by the comparative analysis means.

### Supplementary Note A8

The information processing device according to any one of Supplementary Notes A1 to A4, further including:

a third comparison means for comparing one or more claims included in the present patent application with a target configuration; and

an integration means for examining at least one point of an argument and an amendment with reference to comparison results by the first comparison means, the second comparison means, and the third comparison means.

### Supplementary Information B

The present disclosure includes techniques described in the following Supplementary Notes. However, the present disclosure is not limited to the techniques described in the following Supplementary Notes, and various modifications may be made within the scope described in the claims.

### Supplementary Note B1

An information processing method including:

acquisition processing for acquiring, by at least one processor, a content of a present patent application, a reason for rejection to the present patent application, and a cited document to the present patent application;

first comparison processing for comparing, by the at least one processor, one or more claims included in the present patent application and a content of the cited document without referring to the reason for rejection;

second comparison processing for comparing, by the at least one processor, one or more claims included in the present patent application and the content of the cited document with reference to the reason for rejection; and

response draft creation processing for creating, by the at least one processor, a response draft related to the present patent application with reference to a comparison result by the first comparison processing and a comparison result by the second comparison processing.

### Supplementary Note B2

The information processing method according to Supplementary Note B1, in which

the response draft creation processing includes:

examination processing for examining, by the at least one processor, one or more amendment points related to the present patent application with reference to a comparison result by the first comparison processing and a comparison result by the second comparison processing; and

proposed amendment creation processing for creating, by the at least one processor, one or more proposed amendments related to the present patent application in accordance with an amendment point by the examination processing.

### Supplementary Note B3

The information processing method according to Supplementary Note B2, in which

in the proposed amendment creation processing, the at least one processor creates a plurality of proposed amendments, and

the response draft creation processing includes:

priority determination processing for determining, by the at least one processor, a priority of each of a plurality of proposed amendments created in the proposed amendment creation processing; and

document creation processing for creating, by the at least one processor, remarks and amendments of the claims with respect to one or more proposed amendments having a relatively high priority.

### Supplementary Note B4

The information processing method according to Supplementary Note B3, in which

in the response draft creation processing, the at least one processor includes a machine learning model that is incorporated in at least one of the proposed amendment creation processing and the priority determination processing, learns past intermediate process data, and performs at least one of creation of a proposed amendment and determination of a priority.

### Supplementary Note B5

The information processing method according to Supplementary Note B3 or B4, in which the at least one processor further includes a past case database that stores past intermediate process cases as structured data and is referred to by the proposed amendment creation processing and the priority determination processing.

### Supplementary Note B6

The information processing method according to any one of Supplementary Notes B1 to B4, in which the information processing device includes a natural language processing engine that is incorporated in at least one of the first comparison processing and the second comparison processing and performs comparison using a natural language processing technique.

### Supplementary Note B7

The information processing method according to any one of Supplementary Notes B1 to B4, in which

in the response draft creation processing, the at least one processor executes:

comparative analysis processing for comparing, by the at least one processor, a comparison result by the first comparison processing and a comparison result by the second comparison processing for all of one or more claims included in the present patent application and performing analysis for each component included in the one or more claims; and

amendment classification processing for classifying, by the at least one processor, each of the components into three of superordinate conceptualization amendment, no amendment, and limited amendment with reference to an analysis result by the comparative analysis processing.

### Supplementary Note B8

The information processing method according to any one of Supplementary Notes B1 to B4, further including:

third comparison processing for comparing, by the at least one processor, one or more claims included in the present patent application with a target configuration; and

integration processing for examining, by the at least one processor, at least one point of an argument and an amendment with reference to comparison results by the first comparison processing, the second comparison processing, and the third comparison processing.

### Supplementary Information C

The present disclosure includes techniques described in the following Supplementary Notes. However, the present disclosure is not limited to the techniques described in the following Supplementary Notes, and various modifications may be made within the scope described in the claims.

### Supplementary Note C1

An information processing program for causing a computer to function as an information processing device, the program causing the computer to function as:

an acquisition means for acquiring a content of a present patent application, a reason for rejection to the present patent application, and a cited document for the present patent application;

a first comparison means for comparing one or more claims included in the present patent application with a content of the cited document without referring to the reason for rejection;

a second comparison means for comparing one or more claims included in the present patent application with the content of the cited document with reference to the reason for rejection; and

a response draft creation means for creating a response draft regarding the present patent application with reference to a comparison result by the first comparison means and a comparison result by the second comparison means.

### Supplementary Note C2

The information processing program according to Supplementary Note C1, in which

the response draft creation means includes:

an examination means for examining one or more amendment points related to the present patent application with reference to a comparison result by the first comparison means and a comparison result by the second comparison means; and

a proposed amendment creation means for creating one or more proposed amendments related to the present patent application in accordance with an amendment point by the examination means.

### Supplementary Note C3

The information processing program according to Supplementary Note C2, in which

the proposed amendment creation means generates a plurality of proposed amendments, and

the response draft creation means includes:

a priority determination means for determining a priority of each of the plurality of proposed amendments created by the proposed amendment creation means; and

a document creation means for creating remarks and amendments of the claims with respect to one or more proposed amendments having a relatively high priority.

### Supplementary Note C4

The information processing program according to Supplementary Note C3, in which

the response draft creation means includes:

a machine learning model that is incorporated in at least one of the proposed amendment creation means and the priority determination means, learns past intermediate process data, and performs at least one of creation of a proposed amendment and determination of a priority.

### Supplementary Note C5

The information processing program according to Supplementary Note C3 or C4, further including a past case database that stores past intermediate process cases as structured data and is referred to by the proposed amendment creation means and the priority determination means.

### Supplementary Note C6

The information processing program according to any one of Supplementary Notes C1 to C4, in which

the computer is caused to function as a natural language processing engine that is incorporated in at least one of the first comparison means and the second comparison means and performs comparison using a natural language processing technique.

### Supplementary Note C7

The information processing program according to any one of Supplementary Notes C1 to C4, in which

the response draft creation means includes:

a comparative analysis means for comparing a comparison result by the first comparison means and a comparison result by the second comparison means for all of one or more claims included in the present patent application and performing analysis for each component included in the one or more claims; and

an amendment classification means for classifying each of the components into three of superordinate conceptualization amendment, no amendment, and limited amendment with reference to an analysis result by the comparative analysis means.

### Supplementary Note C8

The information processing program according to any one of Supplementary Notes C1 to C4, in which

the computer is caused to further function as:

a third comparison means for comparing one or more claims included in the present patent application with a target configuration; and

an integration means for examining at least one point of an argument and an amendment with reference to comparison results by the first comparison means, the second comparison means, and the third comparison means.

### Supplementary Information D

The present disclosure includes techniques described in the following Supplementary Notes. However, the present disclosure is not limited to the techniques described in the following Supplementary Notes, and various modifications may be made within the scope described in the claims.

### Supplementary Note D1

An information processing device including:

at least one processor, in which

the at least one processor executes:

acquisition processing for acquiring a content of a present patent application, a reason for rejection to the present patent application, and a cited document to the present patent application;

first comparison processing for comparing one or more claims included in the present patent application and a content of the cited document without referring to the reason for rejection;

second comparison processing for comparing one or more claims included in the present patent application and the content of the cited document with reference to the reason for rejection; and

response draft creation processing for creating a response draft related to the present patent application with reference to a comparison result by the first comparison processing and a comparison result by the second comparison processing.

The information processing device may further include a memory. The memory may store a program for causing the at least one processor to execute each of the processing.

### Supplementary Note D2

The information processing device according to Supplementary Note D1, in which

in the response draft creation processing, the at least one processor executes:

examination processing for examining one or more amendment points related to the present patent application with reference to a comparison result by the first comparison processing and a comparison result by the second comparison processing; and

proposed amendment creation processing for creating one or more proposed amendments related to the present patent application in accordance with an amendment point by the examination processing.

### Supplementary Note D3

The information processing device according to Supplementary Note D2, in which

in the proposed amendment creation processing, the at least one processor creates a plurality of proposed amendments, and

in the response draft creation processing, the at least one processor executes:

priority determination processing for determining a priority of each of a plurality of proposed amendments created in the proposed amendment creation processing; and

document creation processing for creating remarks and amendments of the claims with respect to one or more proposed amendments having a relatively high priority.

### Supplementary Note D4

The information processing device according to Supplementary Note D3, in which

in the response draft creation processing, the at least one processor uses a machine learning model that learns past intermediate process data, and performs at least one of creation of a proposed amendment and determination of a priority in at least one of the proposed amendment creation processing and the priority determination processing.

### Supplementary Note D5

The information processing device according to Supplementary Note D3 or D4, further including a past case database that stores past intermediate process cases as structured data and is referred to by the proposed amendment creation processing and the priority determination processing.

### Supplementary Note D6

The information processing device according to any one of Supplementary Notes D1 to D4, in which the at least one processor uses a natural language processing engine that performs comparison using a natural language processing technique in at least one of the first comparison processing and the second comparison processing.

### Supplementary Note D7

The information processing device according to any one of Supplementary Notes D1 to D4, in which

in the response draft creation processing, the at least one processor executes:

comparative analysis processing for comparing a comparison result by the first comparison processing and a comparison result by the second comparison processing for all of one or more Supplementary Notes D included in the present patent application and performing analysis for each component included in the one or more Supplementary Notes D; and

amendment classification processing for classifying each of the components into three of superordinate conceptualization amendment, no amendment, and limited amendment with reference to an analysis result by the comparative analysis processing.

### Supplementary Note D8

The information processing device according to any one of Supplementary Notes D1 to D4, in which the at least one processor further executes:

third comparison processing for comparing one or more claims included in the present patent application with a target configuration; and

integration processing for examining at least one point of an argument and an amendment with reference to comparison results by the first comparison processing, the second comparison processing, and the third comparison processing.

### Supplementary Information E

The present disclosure includes techniques described in the following Supplementary Notes. However, the present disclosure is not limited to the techniques described in the following Supplementary Notes, and various modifications may be made within the scope described in the claims.

### Supplementary Note E1)

A non-transitory recording medium having recorded therein an information processing program for causing a computer to function as an information processing device, the program causing the computer to execute:

acquisition processing for acquiring a content of a present patent application, a reason for rejection to the present patent application, and a cited document for the present patent application;

first comparison processing for comparing one or more Supplementary Notes E included in the present patent application with a content of the cited document without referring to the reason for rejection;

second comparison processing for comparing one or more Supplementary Notes E included in the present patent application with the content of the cited document with reference to the reason for rejection; and

response draft creation processing for creating a response draft regarding the present patent application with reference to a comparison result by the first comparison processing and a comparison result by the second comparison processing.

The previous description of embodiments is provided to enable a person skilled in the art to make and use the present disclosure. Moreover, various modifications to these example embodiments will be readily apparent to those skilled in the art, and the generic principles and specific examples defined herein may be applied to other embodiments without the use of inventive faculty. Therefore, the present disclosure is not intended to be limited to the example embodiments described herein but is to be accorded the widest scope as defined by the limitations of the claims and equivalents.

Further, it is noted that the inventor's intent is to retain all equivalents of the claimed invention even if the claims are amended during prosecution.

1. An information processing device comprising:
one or more memories storing instructions; and
one or more processors configured to execute the instructions to:
acquire a content of a present patent application, a reason for rejection for the present patent application, and a cited document for the present patent application;
execute a first comparison processing for associating elements of one or more claims included in the present patent application with elements described in the cited document without referring to the reason for rejection;
execute a second comparison processing for associating elements of one or more claims included in the present patent application with elements described in the cited document with reference to the reason for rejection; and
create a response draft regarding the present patent application based on correspondence relationships determined by the first comparison processing and correspondence relationships determined by the second comparison processing.

2. The information processing device according to claim 1, wherein
the one or more processors are configured to execute the instructions to:
examine one or more amendment points related to the present patent application with reference to the comparison result of the first comparison processing and the comparison result of the second comparison processing; and
create one or more proposed amendments related to the present patent application based on the examined amendment points.

3. The information processing device according to claim 2, wherein
the one or more processors are configured to execute the instructions to:
generate a plurality of proposed amendments;
determine a priority of each of the plurality of generated proposed amendments based on at least one of an index indicating patentability of each proposed amendment and an index indicating breadth of rights scope of each proposed amendment, the response draft further including at least one of the index indicating patentability of each proposed amendment and the index indicating breadth of rights scope of each proposed amendment; and
create remarks and amendments with respect to one or more proposed amendments having a relatively high priority.

4. The information processing device according to claim 3, further comprising a machine learning model that is used in at least one of generating the proposed amendments and determining the priority, learns past intermediate process data, and performs at least one of generating a proposed amendment and determining a priority.

5. The information processing device according to claim 3, further comprising a past case database that stores past intermediate process cases as structured data and is accessed during generation of the proposed amendments and determination of the priority.

6. The information processing device according to claim 1, wherein the one or more processors are configured to execute the instructions using a natural language processing engine that is used in at least one of the first comparison processing and the second comparison processing and performs comparison using a natural language processing technique.

7. The information processing device according to claim 1, wherein
the one or more processors are configured to execute the instructions to:
compare the comparison result from the first comparison processing and the comparison result from the second comparison processing for all of one or more claims included in the present patent application and perform analysis for each component included in the one or more claims; and
classify each of the components into three categories: superordinate conceptualization amendment, no amendment, and limited amendment.

8. The information processing device according to claim 2, wherein
the one or more processors are further configured to execute the instructions to:
execute a third comparison processing between one or more claims included in the present patent application and a target configuration; and
determine, through integrated analysis processing, at least one point of an argument and an amendment with reference to comparison results from the first comparison processing, the second comparison processing, and the third comparison processing.

9. An information processing method comprising:
by a computer,
acquiring a content of a present patent application, a reason for rejection for the present patent application, and a cited document for the present patent application;
executing a first comparison processing for associating elements of one or more claims included in the present patent application with elements described in the cited document without referring to the reason for rejection;
executing a second comparison processing for associating elements of one or more claims included in the present patent application with elements described in the cited document with reference to the reason for rejection; and
creating a response draft related to the present patent application based on correspondence relationships determined by the first comparison processing and correspondence relationships determined by the second comparison processing.

10. A non-transitory recording medium that records a program causing a computer to execute:
acquiring a content of a present patent application, a reason for rejection for the present patent application, and a cited document for the present patent application;
executing a first comparison processing for associating elements of one or more claims included in the present patent application with elements described in the cited document without referring to the reason for rejection;
executing a second comparison processing for associating elements of one or more claims included in the present patent application with elements described in the cited document with reference to the reason for rejection; and
creating a response draft related to the present patent application based on correspondence relationships determined by the first comparison processing and correspondence relationships determined by the second comparison processing.

11. The information processing device according to claim 1, wherein
the one or more processors are configured to execute the instructions to:
create the response draft regarding the present patent application by inputting the correspondence relationships determined by the first comparison processing and the correspondence relationships determined by the second comparison processing into a large language model.

12. The information processing method according to claim 9, further comprising:
creating the response draft related to the present patent application by inputting the correspondence relationships determined by the first comparison processing and the correspondence relationships determined by the second comparison processing into a large language model.

13. The non-transitory recording medium according to claim 10, wherein the program further causes the computer to execute:
creating the response draft related to the present patent application by inputting the correspondence relationships determined by the first comparison processing and the correspondence relationships determined by the second comparison processing into a large language model.
